(19) United States
(12) Patent Application Publication
(10) Pub. No.: US 2021/0131745 A1
(43) Pub. Date: May 6, 2021

(54) Thermal Energy Storage and Retrieval System

(71) Applicants: Rabindranath Sharma, Brampton (CA); Viswanath Sharma, Brampton (CA); Bhopal Narain, Brampton (CA); Chandrakant Sharma, Brampton (CA); Seyedshhamaldin Hosseininejad, Burnaby (CA); Raj Krishna Sharma, Brampton (CA); Roydon A. Faser, Kitchener (CA); Edward R. Vrscay, Kitchener (CA)

(72) Inventors: Rabindranath Sharma, Brampton (CA); Viswanath Sharma, Brampton (CA); Bhopal Narain, Brampton (CA); Chandrakant Sharma, Brampton (CA); Seyedshhamaldin Hosseininejad, Burnaby (CA); Raj Krishna Sharma, Brampton (CA); Roydon A. Faser, Kitchener (CA); Edward R. Vrscay, Kitchener (CA)

(21) Appl. No.: 16/926,640

(22) Filed: Jul. 10, 2020

Related U.S. Application Data
(60) Provisional application No. 62/872,665, filed on Jul. 10, 2019.

(51) Int. Cl. F28D 20/00

(52) U.S. Cl. CPC F28D 20/0056; F28D 2020/0069; F28D 2020/0078; F28D 2020/0013

(57) ABSTRACT

A system and method to store and retrieve energy includes a heat source or an energy consumer thermally connected to a fluid. The fluid is transported through a first well fluidically connected to a second well. A slot is sawed into a rock below the earth's surface and a cable and tubing connect the first well to the second well. The cable and the tubing are partially encapsulated by casing, wherein the cable stores heat. A plurality of materials is filled into the slot. A first hole is disposed beneath a first rig and surrounds the first well. A second hole is disposed beneath a second rig and surrounds the second well. The first hole and the second hole are configured to be vertical or slanted.

### CROSS-REFERENCE TO RELATED APPLICATIONS

This application claims priority from U.S. Provisional Application Ser. No. 62/872,665, filed on Jul. 10, 2019, which is hereby incorporated herein by reference in its entirety.

### FIELD OF INVENTION

The present invention relates to systems and methods for the storage and retrieval of energy.

### BACKGROUND OF THE INVENTION

While there are heat storage systems, the heat storage systems do not use slot or fracked rock below the surface to store the heat. Instead, heat storage in the containers above the surface of the earth or in an aquifer is below the surface and within a single well. Also, surface level ponds are used to store heat on a seasonal basis. This makes heat compression recapture from compressed air storage systems and heat storage from solar, nuclear, biofuel, wind-generated heat, and waste heat sources inefficient or impractical.

Systems and methods which store and retrieve heat in the subsurface region using fracked and non-fracked systems on a daily cycle or seasonal cycle are needed.

### Brief Summary of Embodiments of the Invention

In a variant, a system for storing and retrieving energy from or to the subsurface region is provided. The system includes: a heat source or an energy consumer thermally connected to a first fluid, a slot sawed into a rock, a cable and tubing operatively connected the first well to the second well, a plurality of materials filled into the slot, a first hole disposed beneath a first rig, and a second hole disposed beneath a second rig. The first fluid is transported through a first well fluidically connected to a second well. The slot is below an earth surface. The cable and the tubing are partially encapsulated by casing, wherein the cable stores heat. The plurality of materials is in a liquid state or gas state. The first hole surrounding the first well and the second hole surrounding the second well are configured to be vertical or slanted.

In another variant, the tubing is operatively connected to the cable such that a first end of the tubing is clamped to a first end of the cable within the first rig and the second end of the tubing is clamped to a second end of the cable within the second rig.

In yet another variant, the plurality of materials is selected from the group consisting of steel balls, scrap steel, gravel, alumina, bauxite, water, air, and ropes for heat storage.

In a further variant, the slot is disposed in a vertical direction, a horizontal direction, or an inclined direction.

In yet a further variant, the first well and the second well are of a circular shape, a rectangular shape, an ellipsoidal shape, or a square shape.

In yet another variant, the heat source may be solar energy, nuclear energy, geothermal energy, electrical, organic wastes, and converted wind turbine energy.

In yet another variant, the fluid is in a gas phase, liquid phase, supercritical phase, or dual phase.

In yet another variant, the first fluid is transported through the slot, the heat source, and the energy consumer in a single closed-loop system, a binary closed-loop system, or an open loop system.

In yet another variant, the binary closed-loop system includes a second fluid and a heat exchanger. The heat exchanger is fluidically connected to the first fluid, the second fluid, and the slot.

In yet another variant, the single-loop system includes the first fluid transported from the heat source to the slot in a heated state and subsequently transported from the slot to the heat source in a cooled state.

In yet another variant, the single-loop system includes the first fluid transported from the energy consumer to the slot in a cooled state and subsequently transported from the slot to the energy consumer in a heated state.

In a variant, a system for storing and retrieving sub-surface energy is provided. The system includes: a fractured body of rock, a thermal fluid circulated through the fractured body of rock via tubing, a rock mass below the earth surface, a first well disposed within a first hole, and a second well disposed within a second hole. The fractured body or rock resides below an earth surface and the rock mass is a continuation of the fractured body of rock. The first hole is operatively connected to the fractured body of rock and the second hole is operatively connected to the fractured body of rock. The first well contains at least a first segment, a second segment, and a third segment. The second well contains at least a fourth segment and a fifth segment. The first segment, the second segment, the third segment, the fourth segment, and the fifth segment include perforations fitted with valves. The first hole and the second hole are configured to be vertical or slanted.

In yet another variant, the first well and the second well include the valves and a cement layer connected to a first tubing layer. The first tubing layer is connected to a first hollow layer. The first hollow layer is connected to a second tubing layer. The second tubing layer is connected to the second hollow layer. The valves span across the cement layer, the first tubing layer, the first hollow layer, and the second tubing layer.

In a further variant, the second segment and the third segment include at least one angled fin, at least one outer flange, a thin bearing, and a disc bearing.

In yet a further variant, the first segment and the fourth segment include at least one flange and a cement layer.

In yet another variant, the tubing is connected to (i) electrical motors for causing rotation, (ii) a thin bearing, and (iii) a disc bearing.

In yet another variant, the perforations on the outer tubing are covered with sieves to prevent sand from entering between the cylinders. The sieves are disposed on inner or outer faces or both the inner and outer faces of an outer cylinder.

In yet another variant, the thermal fluid flows from any combination of the first, second, third, fourth, and fifth segments such that the thermal fluid is hot when released by the first well and the thermal fluid is cold when received by any combination of segments in the second well.

In yet another variant, the thermal fluid flows from the second segment to the third segment such that the thermal fluid is hot when received by the first well and the thermal fluid is cold when released by the second well. A bottom level of the second well is higher than a bottom level of the first well, or the bottom level of the second well is identical level to the bottom level of the first well.

In yet another variant, the thermal fluid flows from the second segment to the third segment such that the thermal fluid is hot when released by the first well and the thermal fluid is cold when received by the second well. A bottom level of the second well is higher than a bottom level of the first well, or the bottom level of the second well is identical level to the bottom level of the first well.

Other features and aspects of the invention will become apparent from the following detailed description, taken in conjunction with the accompanying drawings, which illustrate, by way of example, the features in accordance with embodiments of the invention.

The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a depiction of an energy storage and retrieval environment where the slot is horizontal and filled with thermal material for heat storage and retrieval.

FIG. 2 is a depiction of an energy storage and retrieval environment where the slot is vertical and filled with thermal material for heat storage and retrieval.

FIG. 3 is a depiction of an energy storage and retrieval environment where the slot is U-shaped.

FIG. 4A and FIG. 4B are depictions of the flow of thermal fluid in an energy storage and retrieval environment.

FIG. 5 and FIG. 6 are depictions of a binary loop where there is slot filled with thermal material for heat storage and retrieval.

FIG. 7 and FIG. 8 are depictions of a single loop where there is a slot with thermal material for heat storage and retrieval.

FIG. 9, FIG. 10, FIG. 11, and FIG. 12 are depictions of a rock reservoir where there is fractured rock used for heat storage and retrieval.

FIG. 13 is a depiction of the vertical well for controlling flow through different segments (segmented flow). For non-segmented flow the wells are not perforated (not shown).

FIG. 14 is a depiction a cross-section of the vertical well for segmented flow.

FIG. 15 is another depiction of the rock reservoir containing fractured rock.

FIGS. 16 and 17 are depictions of a binary loop containing fractured rock.

FIG. 18, FIG. 19, FIG. 20, FIG. 21, FIG. 22, and FIG. 23 are depictions of segments in the vertical wells.

FIG. 24 is a depiction of a flow-controlled bi-cylindrical (FCB) valve.

FIG. 25, FIG. 26, and FIG. 27 are depictions of cross sections of the FCB valve.

### DETAILED DESCRIPTION OF THE EMBODIMENTS OF THE INVENTION

The systems and methods herein use slot drilling or rock fracturing at the subsurface level. During slot drilling, a slot is abrasively sawed into a rock using a rope studded with: (i) industrial diamonds or (ii) other hard abrasive material within a Non-Fracking Thermal Energy Storage and Retrieval (NF-TESR) system. The rope itself may be made with the abrasive material. The slot may have a thickness of a fraction of an inch to a few inches, but may be larger. Once a slot is sawed, the slot may be expanded by other mechanical techniques. The slot, which is filled with steel balls, scrap steel, gravel, or other materials (SFM), may be below the surface of the earth or oriented in a vertical, horizontal, or inclined position. A thermal fluid circulates through the slot to exchange thermal energy with the material that has filled the slot. Above the surface of the earth, this heat is removed from the fluid that is coming up from the subsurface region by a second fluid. The heat may be delivered to a consumer directly. During compression of air, a heat of compression from the Compressed Air Energy Storage (CAES) system is stored. Sub-Surface Thermal Energy Storage/Retrieval System (SS-ThEnStoR) of the systems and methods herein (not CAES) uses the fractured rock at the subsurface level (below the earth's surface) to store or retrieve the heat of compression within the subsurface reservoir environment.

The systems and methods involve, but are not limited to, the following enumerated aspects [1]-[14].

Aspect [1]: In the case of non-segmented flow, there are two or more vertical or slanted wells (holes) used to introduce and retrieve heat to the subsurface region via thermal fluid.

Aspect [2]: Tubes (circular, ellipsoidal, rectangular, or any cross-sectional shape) are inserted into the vertical or slanted wells.

Aspect [3]: The tubes in aspect [2] can be of insulated material or heat storage material. The cement can be of either material, as described above or below.

Aspect [4]: A slot or fracked rock is in between the vertical or slanted wells.

Aspect [5]: The slot may be horizontal or slanted.

Aspect [6]: The slot may be filled with material for absorbing and storing heat. The one or more of the wells may also be partially or fully filled with this material.

Aspect [7]: Thermal fluid (liquid or gas) may flow through the slot or fracked rock to deposit heat and remove heat from the fracked rock or slot.

Aspect [8]: In the case of segmented flow, the two or more vertical or slanted wells (holes) may be used to introduce and retrieve heat from the subsurface region via thermal fluid may be perforated.

Aspect [9]: For the non-segmented flow, tubes (circular, ellipsoidal, rectangular, or any cross-sectional shape) are inserted into the wells and cemented to the surrounded earth, wherein the wells are not perforated.

Aspect [10]: For the segmented flow, the two or more vertical or slanted wells (holes) are equipped with and an additional internal concentric well each.

Aspect [11]: The additional concentric tubes from aspect [4] are separated by the outer tube by thin bearings and rest at the bottom on disk bearings. One or more of these bearings may be used in cases of very low friction or none may be necessary.

Aspect [12]: From aspect [5], the internal tubes are fixed with fins such that water flow can rotate the fins to a particular angle, at which stoppers are disposed to stop the rotational motion.

Aspect [13]: From aspect [6], the rotational motion may also be achieved by an electrical motor attached to the inner tube. In this case, the fins are optional.

Aspect [14]: The lower ends of the entrance wells and the exit wells may be at the same vertical heights or at different vertical heights with respect to each other.

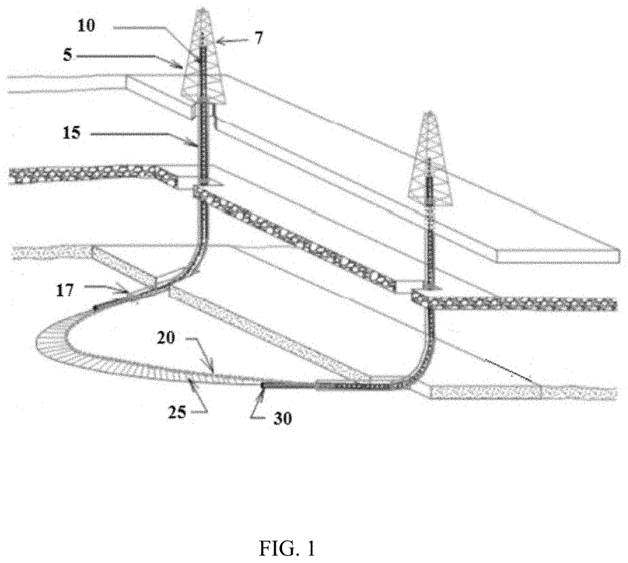

Referring to FIG. 1, slot drilling is performed to yield a thermal storage and retrieval environment with a horizontal slot. In this NF-TESR system, the horizontal slot is below the surface of the earth and has a thickness between a fraction of an inch to a few inches. Slot filled materials (SFM) are filled into the horizontal slot. The SFM is in a liquid phase, gas phase, or solid phase (e.g., cables made from selective materials, or various shapes of pebbles (spherical etc.)) for storing and retrieving heat. Some examples of the SFM include steel balls, scrap steel, gravel, alumina, bauxite, water, air, ropes for heat storage, or any other material used for heat storage. In FIG. 1, cable 20 is within the horizontal slot 25 (i.e., a single slot, shaded with lines). Cable 20 cuts the slot in this horizontally, thin formation. The horizontal cut increase the surface area through which thermal fluid circulates through the slot. The thermal fluid is in a gas phase, liquid phase, supercritical phase, or dual phase. In other embodiments, the slot may be vertical or inclined (not shown). In the NF-TESR system, wells A and B are vertically aligned but may be inclined to the vertical, which may be of a circular shape, rectangular shape, ellipsoidal shape, or a square shape. The dimensions of wells A and B may be adjusted to adjust the rate of flow (or transport) of the thermal fluid. Tubing 10 surrounding cable 20 is disposed within a first vertical hole and a second vertical hole extending through the sub-surface region of the earth and horizontal slot 25 in the sub-surface region of the earth. Part of tubing 10 surrounding cable 20 extends out of a first vertical hole at a first end at rig 5 and a second vertical hole at a second end at rig 5. Tubing 10 is clamped to the end of cable 20 by clamp 7 in rig 5. Tubing 10 may be tensioned and reciprocated by rig 5.

Well A and well B contain casing 15 (e.g., cement) surrounding tubing 10, wherein tubing 10 surrounds cable 20. Cable 20 is composed of an abrasive within tubing 10. Well A is disposed within the first vertical hole at the first end and well B is disposed within the second vertical hole at the second end. Well A disposed in the first vertical hole and well B disposed in the second vertical hole are operatively connected to each other by cable 20 in horizontal slot 25. End 17 terminates casing 15 into the horizontal slot at a first end and at a second end such that a portion of tubing 10 surrounding cable 20 in horizontal slot 25 is in direct contact with sub-surface rock (i.e., the contact zone). Within the NF-TESR system, movement 30 occurs where tubing 10 moves with cable 20 inside casing 15.

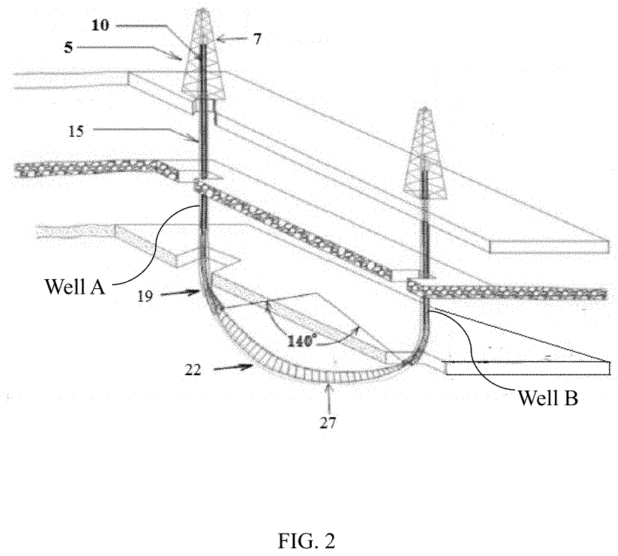

Referring to FIG. 2, slot drilling is performed to yield a thermal storage and retrieval environment with a vertical slot. In this NF-TESR system, the vertical slot is below the surface of the earth and has a thickness between a fraction of an inch to a few inches. Slot filled materials (SFM) are filled into the vertical slot, wherein the SFM is in a liquid phase, gas phase, or solid phase (e.g., a cable) for storing and retrieving heat. Some examples of the SFM include steel balls, scrap steel, gravel, alumina, bauxite, water, air, ropes for heat storage, or any other material used for heat storage. In FIG. 2, cable 22 is within the vertical slot. Cuts 27 are disposed in cable 22 such that there are upward cuts in thin formation. The upward cuts increase the surface area through which thermal fluid circulates through the slot. The thermal fluid is in a gas phase, liquid phase, supercritical phase, or dual phase. In the NF-TESR system, wells A and B are vertically aligned, which can be of a circular shape, rectangular shape, ellipsoidal shape, or a square shape. The dimensions of wells A and B can be adjusted to adjust the rate of flow (or transport) of the thermal fluid. Tubing 10 surrounding cable 20 is disposed within a first vertical hole and a second vertical hole extending through the sub-surface region of the earth and the vertical slot in the sub-surface region of the earth. Part of tubing 10 surrounding cable 20 extends out of a first vertical hole at a first end at rig 5 and a second vertical hole at a second end at rig 5. Tubing 10 is clamped to the end of cable 22 by clamp 7 in rig 5. Tubing 10 may be tensioned and reciprocated by rig 5.

Well A and well B contain casing 15 (e.g., cement) surrounding tubing 10, wherein tubing 10 surrounds cable 22. Cable 22 is composed of an abrasive within tubing 10, whereby cable 22 does not move relative to reciprocating tubing 10. Well A is disposed within the first vertical hole at the first end and well B is disposed within the second vertical hole at the second end. Well A in the first vertical hole and well B in the second vertical hole are operatively connected to each other by cable 22 in the vertical slot. End 19 terminates casing 15 into the vertical slot at a first end and at a second end such that a portion of tubing 10 surrounding cable 22 in the vertical slot is in direct contact with sub-surface rock (i.e., the contact zone). For example, cable 22 is cutting upward within the 140 degree contact zone.

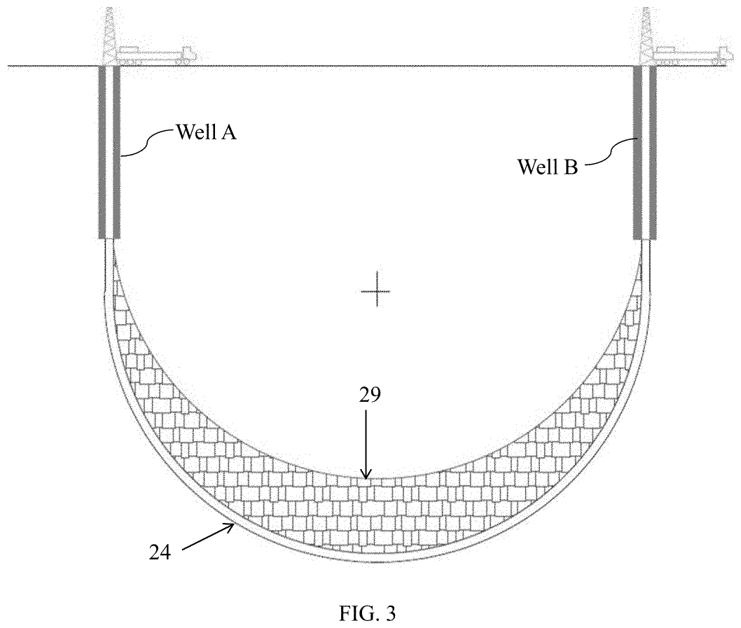

Referring to FIG. 3, slot drilling is performed to yield a thermal storage and retrieval environment with a U-shaped slot. In this NF-TESR system, the U-shaped slot is below the surface of the earth and has a thickness between a fraction of an inch to a few inches. Slot filled materials (SFM) are filled into the vertical slot, wherein the SFM is in a liquid phase, gas phase, or solid phase (e.g., a cable) for storing and retrieving heat. Some examples of the SFM include steel balls, scrap steel, gravel, alumina, bauxite, water, air, ropes for heat storage, or any other material used for heat storage. If the U-shaped slot is not filled with SFM, the heat is stored in the surrounding rock 29. The thermal fluid is in a gas phase, liquid phase, supercritical phase, or dual phase. In the NF-TESR system, wells A and B are vertically aligned, which may be of a circular shape, rectangular shape, ellipsoidal shape, or a square shape. The dimensions of wells A and B may be adjusted to adjust the rate of flow (or transport) of the thermal fluid. Tubing 24 is disposed within a first vertical hole and a second vertical hole extending through the sub-surface region of the earth and the vertical slot in the sub-surface region of the earth. Tubing 24 extends out of a first vertical hole at a first end at rig 5 and a second vertical hole at a second end at rig 5.

Well A and well B contain casing (e.g., casing 15) surrounding tubing 24. Well A is disposed within the first vertical hole at the first end and well B is disposed within the second vertical hole at the second end. Well A in the first vertical hole (but may be inclined) and well B in the second vertical hole (but may be inclined) are operatively connected to each other by tubing 24 in the U-shaped slot. The casing terminates just before tubing 24 curves into the U-shaped slot at a first end and at a second end such that a portion of tubing 24 in the U-shaped slot is in direct contact with surrounding rock 29.

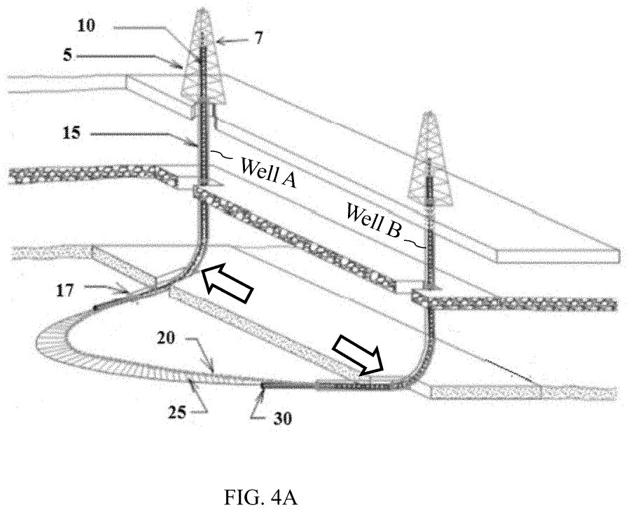

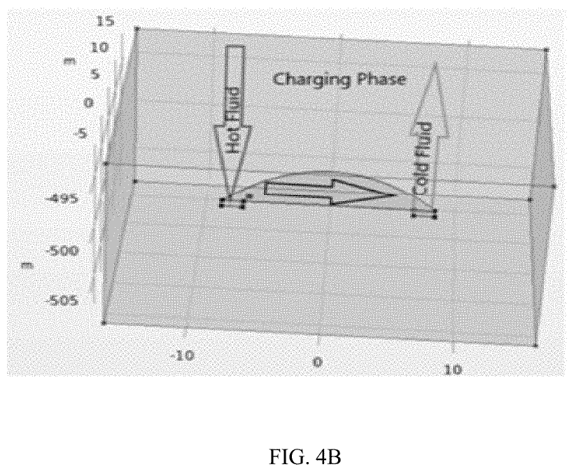

Referring to FIG. 4A and FIG. 4B, heat is: (i) collected from any source, such as solar energy, nuclear energy, geothermal energy, electrical, organic wastes, converted wind turbine energy, and other forms of energy; and (ii) then delivered into the ground and to the materials (e.g., SFM) in the slot or to the fracked rock. Also, heat is retrieved from the subsurface region (e.g., the slot containing cable 20 in FIG. 4A) and delivered to the surface region (e.g., the interface between rigs 5 and B and wells A and B). This is accomplished by the thermal fluid. The thermal fluid is siphoned to and from the subsurface region containing a slot through wells A and B. The thermal fluid flows over the SFM in the slot. The thermal fluid delivers the heat to the SFM, thereby increasing the surface area over which heat transfer takes place. When there is demand for the heat, the flow of the thermal fluid is reversed through the slot to recover the heat. Instances where NF-TESR system is used only for heat mining (just removing heat from the ground), the SFM gathers heat from the surrounding subsurface rock and delivers the heat to the thermal fluid, such the thermal fluid enters into the NF-TESR system in a cold state and leaves the NF-TESR system in a hot state. The thermal fluid also takes heat directly from the walls of the slot (as depicted by arrows). In these instances, the only heat source is the subsurface rock. Thereby, a single directional flow with no accompanying reverse flow is achieved.

Processes where the NF-TESR system is used for both heat storage and retrieval involves: (i) Flow 1, where the thermal fluid in a hot state from well A is transported through the slot and over the SFM and then exits from well B at the other end (see FIG. 4A); (ii) heat deposited to the SFM and the surrounding rocks through the slot walls; and (iii) Flow 2, where heat is retrieved with thermal fluid in the cold state entering through well B and leaving through well A (i.e., Flow 1 is reversed). In FIG. 4A, a 3-dimensional graph represents Flow 1 where: the thermal fluid in a hot state enters into the sub-surface earth via Well A, the thermal fluid flows through slot, and the thermal fluid in a cold state exits out of the sub-surface earth via Well B. Thermal fluid may flow through the slot in a binary closed loop system (two independent loops) or a single closed loop system.

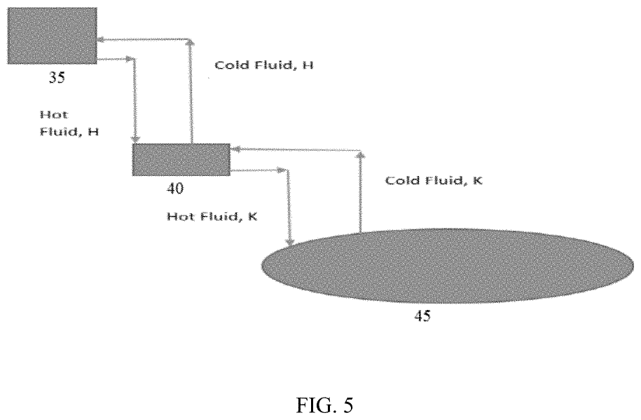

Referring to FIG. 5, thermal fluid obtains the heat from the above ground heat source 35 (using fluid H in a hot state) in a two-loop system. In this variant of the NF-TESR system, the heat of fluid H is transferred to another fluid, resulting in fluid K in a hot state via heat exchanger 40. The heat from fluid K in a hot state is transported to slot 45 (i.e., the horizontal, vertical, and U-shaped slot as described above). The heat may remain in slot 45 such that fluid K is now in a cold state. Fluid K in a cold state is transported to heat exchanger 40, from which fluid H in a cold state is transported to heat source 35. Stated another way, both fluids K and H are in independent loops. More specifically, well A may be connected to well B through a pump as to force fluid K through the slot for the retrieval and storage of heat.

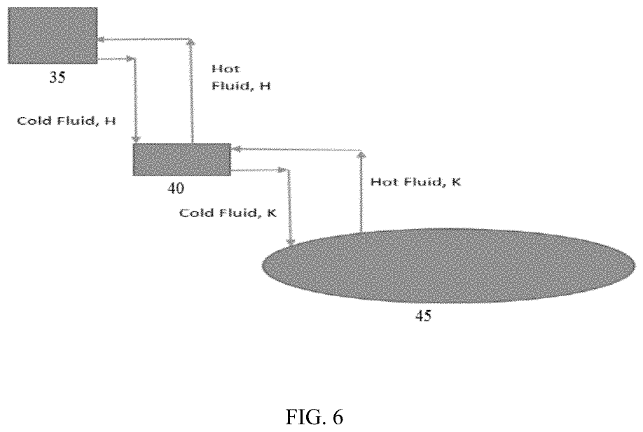

Referring to FIG. 6, heat is retrieved from slot 45, SFM, and surrounding bedrocks in a two-loop system. In this variant of NF-TESR system, fluid H in a cold state is transferred to another fluid, resulting in fluid K in a cold state via heat exchanger 40. Fluid K in a cold state is transported to slot 45 (i.e., the horizontal, vertical, and U-shaped slot above). The heat may exit slot 45 such that fluid K is now in a hot state. Fluid K in a hot state is transported to heat exchanger 40, from which fluid H in a hot state is transported to above ground heat source 35. Stated another way, both fluids K and H are in independent loops. More specifically, well A may be connected to well B through a pump as to force fluid K through the slot for the retrieval and storage of heat.

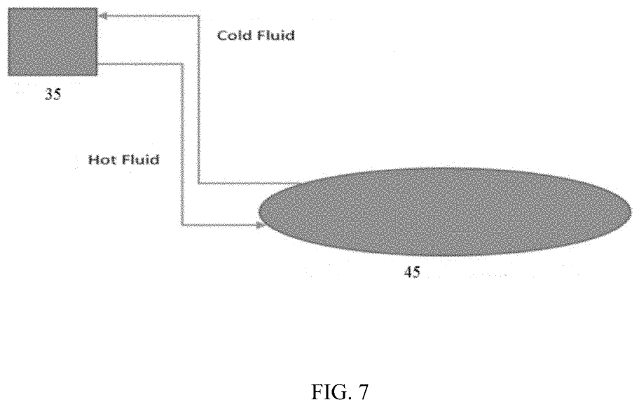

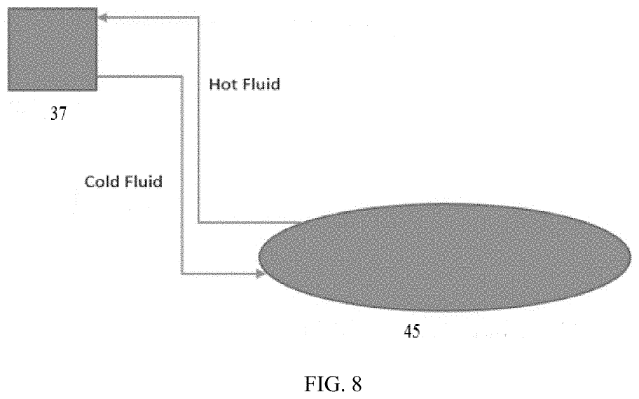

Referring to FIG. 7 and FIG. 8, a single-loop system circulates a single fluid within a NF-TESR system for operating a heat-loading phase and heat-unloading phase, respectively. In certain instances, a pump is not required. For example, if supercritical CO₂ is used as the thermal fluid, supercritical carbon dioxide (CO₂) absorbs heat from the sub-surface slot 45 and rises by sheer buoyancy force to the surface level through well B. The heat of the supercritical CO₂ is released at the surface level as the supercritical CO₂ flows from well B to well A above the surface. The supercritical CO₂ becomes heavier, whereby gravity is enough to cause supercritical CO₂ to flow down well A. This cycle repeats. In the single-loop heat loading phase, thermal fluid in a hot state from above ground heat source 35 is transported to slot 45 and returns thermal fluid in a cold state to the above ground heat source 35. Heat from thermal fluid has been absorbed by slot 45. Thereby, the single-loop heat loading phase stores energy. In the single-loop heat unloading phase, thermal fluid in a cold state from above ground energy consumer 37 is transported to slot 45 and returns thermal fluid in a hot state to the above ground energy consumer 37. Heat from thermal fluid has been released from slot 45. Thereby, the single-loop heat unloading phase retrieves energy.

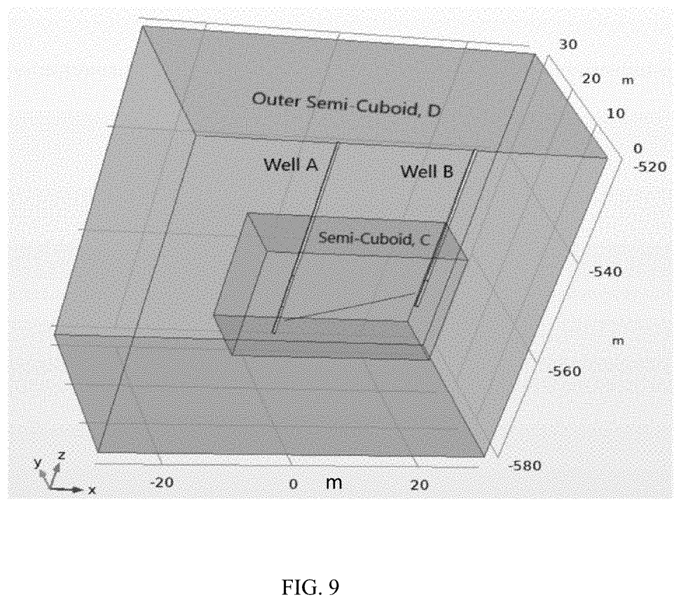

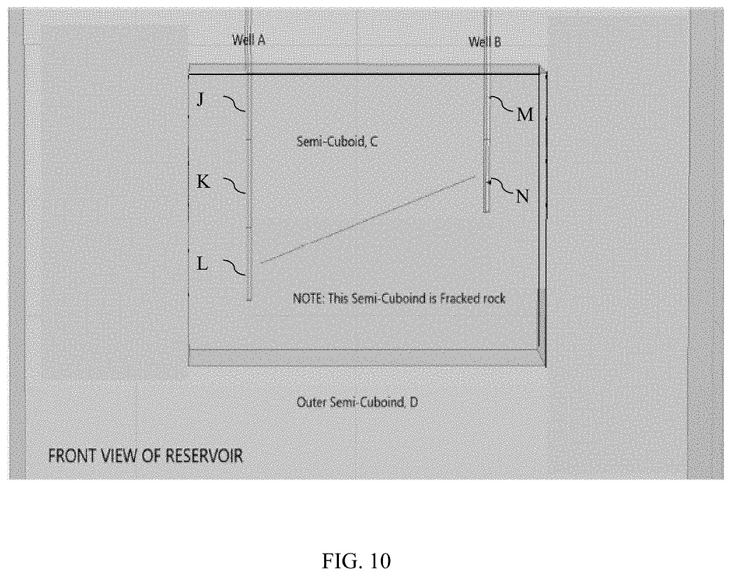

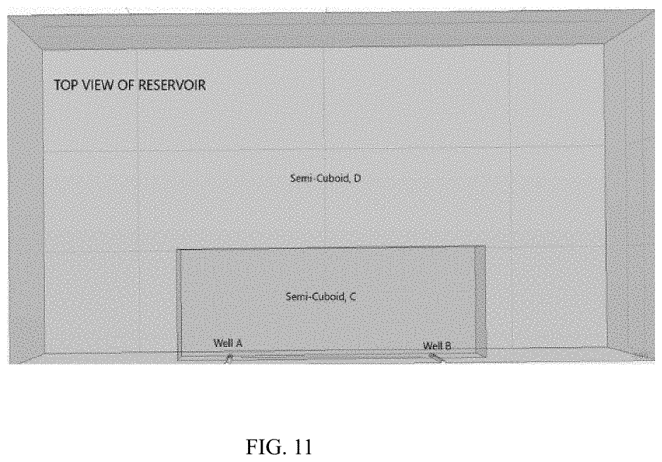

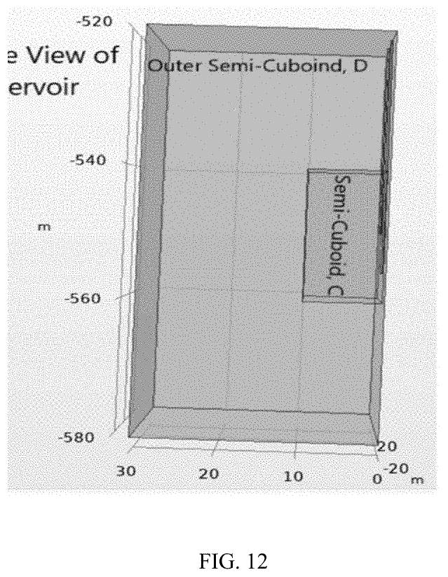

While FIG. 1—FIG. 8 depict a NF-TESR system, FIG. 9—FIG. 27 depict a Sub-Surface Thermal Energy Storage/Retrieval (SS-ThEnStoR) system.

Referring to FIGS. 9-12, the fractured rock at the subsurface level (below the earth's surface) stores heat of compression from the Compressed Air Energy Storage (CAES) system. FIG. 9 depicts a semi-heat reservoir used in the SS-ThEnStoR, which is a cut through the center of the reservoir about the xz-plane that is symmetrical about the front face (xz-plane). FIG. 9 depicts a fractured body of rock represented as region C, which is a semi-cuboid. The outer region D, which is a semi-cuboid, is a continuation of the rock mass below the earth's surface. Region C, which is a semi-cuboid, has been frequently fracked. Thereby, region C has a much larger permeability than region D. While regions C and D are depicted as semi-cuboids in FIG. 9, regions C and D may be ellipsoids, cylinders, or any three-dimensional shape necessary for the dynamics of the system. Also, regions C and D can be a single body of rock of the same permeability or region C can have a larger or smaller permeability than region D. In FIG. 9, well A is at one end of the entrance of the vertical hole to the body of fractured rock below and well B is the other end. Well A and B may be of a circular shape, rectangular shape, ellipsoidal shape, or a square shape. The dimensions of wells A and B may be adjusted to control the rate of flow (or transport) of the thermal fluid. A thermal fluid circulates through the slot to exchange thermal energy with the material stores in it. The dimensions shown on the diagram of FIG. 9 provide a perspective of scalability. These dimensions can be as modified as necessary to store the amount of heat that needs to be stored. As per FIG. 9, the top of region D is 520 meters (m) below the surface of the earth but can be deeper because the type of rock needed might not be at that depth and the temperature of the earth at that depth might not be sufficient. The depth may also be smaller than this for the same reasons.

FIG. 10 and FIG. 15 depict the frontal view of the reservoir shown in FIG. 9. The vertical well A is depicted as having three segments—section J, K, and L, but there may be more. The vertical well B is depicted as having two segments—M and N, but there may be more. The uppermost segments for Wells A and B are segments J and M, which continue all the way to the earth's surface. The other three segments, K, L, and N are contained within the region C, which is semi-cuboid. The bottom of the wells A and B are closed off from the fractured rock. The bottom of well B is higher than well A. This difference may be adjusted to accommodate the dynamics of the system. The top view of the reservoir is shown in FIG. 11. The side view of the reservoir is shown in FIG. 12. Wells A and B are perforated with holes in sections J, K, L, M, and N. These holes may be of any diameter necessary to accommodate the dynamics of the system. The number of these perforations is also determined by the system dynamics. These perforations are fitted with break valves. The type of break valves is chosen based on the dynamics of the system.

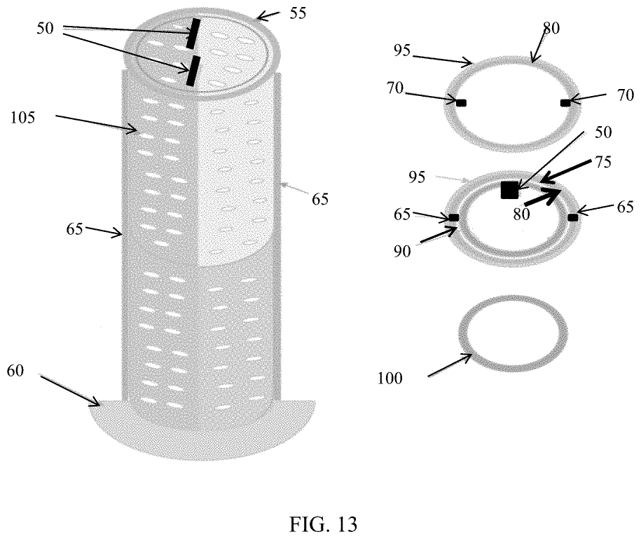

Referring to FIG. 13, wells A and B are depicted as circular for the sake of simplicity. As described above, wells A and B may be of any shape (round, square, etc.). In FIG. 13, sections K and L of well A are depicted in the upper-left diagram where there are two units of angled rectangular fin 50 attached to thin bearing 55. The outer flange 65 surrounds the walls of well A on the sides and is operatively connected disc bearing 60. The walls of well A contain perforations 105. In FIG. 13, the upper right diagram is the top view of sections J and M of wells A and B. In FIG. 13, the middle right diagram is sections K and L of wells A and B. In FIG. 13, the lower right diagram is the cover section of sections K and L.

In the upper-right diagram of FIG. 13, cement 95 is a depicted as a ring structure binding outer wellbore tubing material 75 (depicted as an outer cylinder) to the subsurface rock. The inner wellbore tubing material 80 (depicted as an inner cylinder) is bounded. The tubing materials 75 and 80 may be PVC, metal, ceramic, or any other material deemed appropriate for the dynamics of this system. The middle right diagram of FIG. 13, there is a slight gap 90 between the wellbore tubing (outer cylinder) and a second wellbore tubing (inner cylinder) in sections K and L well A. The second wellbore tubing may be optional.

Gap 90 allows for a thin film of lubrication (perhaps the thermal fluid itself) to maintain inner well tubing material 80. This film makes moving and removing inner well tubing material 80 to and from the surface of the earth easier. Cap 100 may be placed on top of sections K and L, wherein cap 100 is disposed over the base of the inner cylinder and gap between the inner cylinder and outer cylinder.

At the top of gap 90 and between the two cylinders, thin bearing 55 may be used, depending on the dynamics of the system. Disc bearing 60 may also be placed at the bottom of the inner tubing (not represented in diagram). The base of the inner tubing is secured to a thin disc bearing.

There are two rectangular flanges—flange 65—on the outer surface of the inner cylinder. The two unit of flange 65 run longitudinally and are diametrically opposite to each other. Similarly, there are two diametrically opposite units of flange 70 that run longitudinally along the inside of the outer cylinder.

For another mode of operation, angled rectangular fins 50 are placed on the inside of the inner ring. Angled rectangular fins 50 may be placed at random locations such that they appear in pairs and are diametrically opposite to each other. Angled rectangular fins 50 may be angled in the same direction. The length, width, and thickness of angled rectangular fins 50 are determined by the dynamics of the system. Instead of fins, electrical motors can be connected at the top or bottom of the wells (not shown) for actuating the rotation.

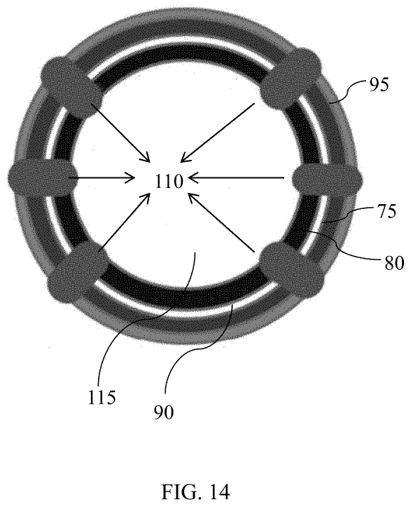

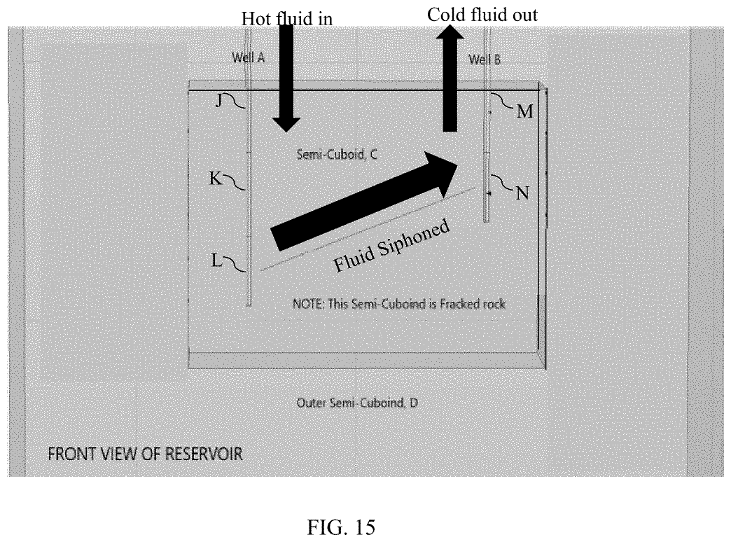

Referring to FIG. 14, a cross-section through a vertical well through break valves 110 is depicted. Both of the well tubing materials in sections K and L are perforated with numerous holes as perforations 105. Placement of break valves 110 in perforations 105 is one way to accommodate flow in a single direction. There may be six units of break valves 110, which are: (i) fitted across (i.e., span across) cement 95 (outermost cylinder in FIG. 14), outer tubing 75 (second outer most cylinder in FIG. 14), gap 90 (third outermost cylinder in FIG. 14), and inner tubing (fourth outermost cylinder in FIG. 14); and (ii) terminated at hollow region 115. The break valves 110 are not placed on the outer wellbore tubing in instances of the optional inner wellbore tubing. The break valves may be placed in the perforations of the optional inner tubing only, despite both the inner and outer wellbore tubing are perforated. The perforations for both the inner and outer wellbore tubing are precisely aligned for flow to take place. Additionally, if the optional tubing is used, maintenance is obviated where the break valves may be fitted in the perforations and across the tubing for stability purposes. The inside and/or the outside of the outer cylinder may or may not be covered with a sieve to block sand particles to be introduced in between the cylinders.

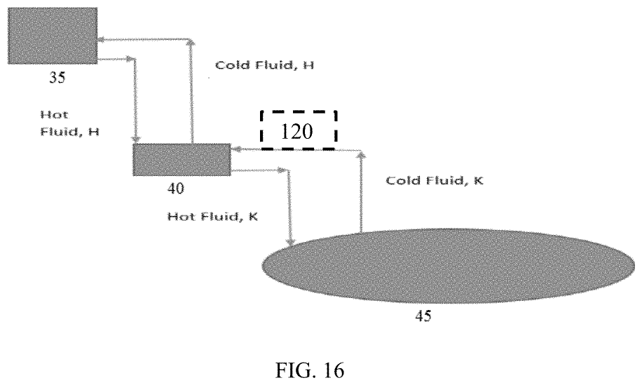

Referring to FIG. 16, thermal fluid obtains the heat from the above ground heat source 35 (using fluid H in a hot state) in a two-loop system. In this variant of SS-ThEnStoR, the heat of fluid H is transferred to another fluid, resulting in fluid K in a hot state via heat exchanger 40. The heat from fluid K in a hot state is transported to fractured rock 45. The heat may remain in fractured rock 45 such that fluid K is now in a cold state. Fluid K in a cold state is transported to heat exchanger 40, from which fluid H in a cold state is transported to heat source 35. Stated another way, both fluids K and H are in independent loops. More specifically, well A may be connected to well B through pump 120 as to force fluid K through fractured rock 45 for the storage of heat.

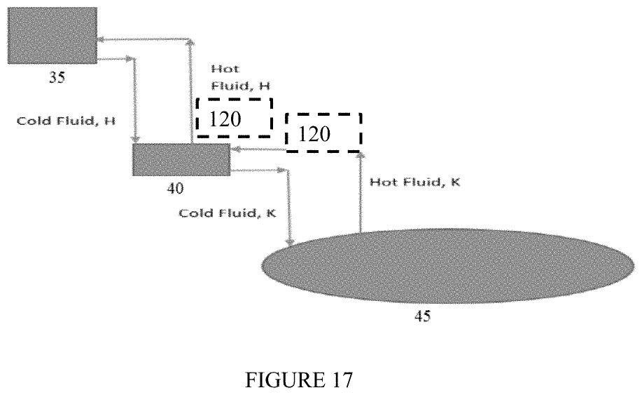

Referring to FIG. 17, heat is retrieved from the fractured rock in a two-loop system. In this variant of SS-ThEnStoR, fluid H in a cold state is transferred to another fluid, resulting in fluid K in a cold state via heat exchanger 40. Fluid K in a cold state is transported to fractured rock 45. The heat may exit the fractured rock such that fluid K is now in a hot state. Fluid K in a hot state is transported to heat exchanger 40, from which fluid H in a hot state is transported to above ground heat source 35. Stated another way, both fluids K and H are in independent loops. More specifically, well A may be connected to well B through two units of pump 120 as to force fluid K through the fractured rock for the retrieval of heat.

While not depicted, a single-loop system circulates a single fluid within SS-ThEnStoR for operating a single loop heat-loading phase and single loop heat-unloading phase, respectively. In certain instances, a pump is not required. For example, if supercritical CO₂ is used as the thermal fluid, supercritical CO₂ absorbs heat from fractured rock 45 and rises by sheer buoyancy force to the surface level through well B. The heat of the supercritical CO₂ is released at the surface level as the supercritical CO₂ flows from well B to well A above the surface. The supercritical CO₂ becomes heavier. Thereby, gravity is enough to cause supercritical CO₂ to flow down well A. This cycle repeats. In the single-loop heat loading phase, thermal fluid in a hot state from above ground heat source 35 is transported to fractured rock 45 and returns thermal fluid in a cold state to the above ground heat source 35. Heat from thermal fluid has been absorbed by fractured rock 45. Thereby, the single-loop heat loading phase stores energy. In the single-loop heat unloading phase, thermal fluid in a cold state from above ground energy consumer 37 is transported to fractured rock 45 and returns thermal fluid in a hot state to the above ground energy consumer 37. Heat from thermal fluid has been released from fractured rock 45. Thereby, the single-loop heat unloading phase retrieves energy. For the case of removing heat from compressed air from a compressor (as in the case of Compressed Air Energy Storage System), the single loop can be an open loop (not shown). This means that the compressed air is sent directly to the subsurface region via one of the vertical or slant well to give up its heat to the material in the slot or to the fractured rock. The cooler air exits from the other vertical or slants well and goes for storage in a cavern or a storage tank. Additionally, heated air from above surface (heated by a compressor) may also be sent directly to the subsurface region through a well to give up its heat to the material in fractured rock 45 (or slot 45). The cool air is returned to the surface through another well to go to storage.

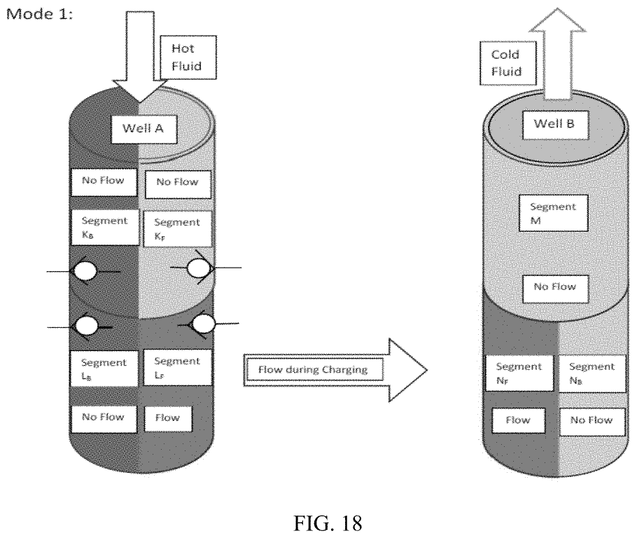

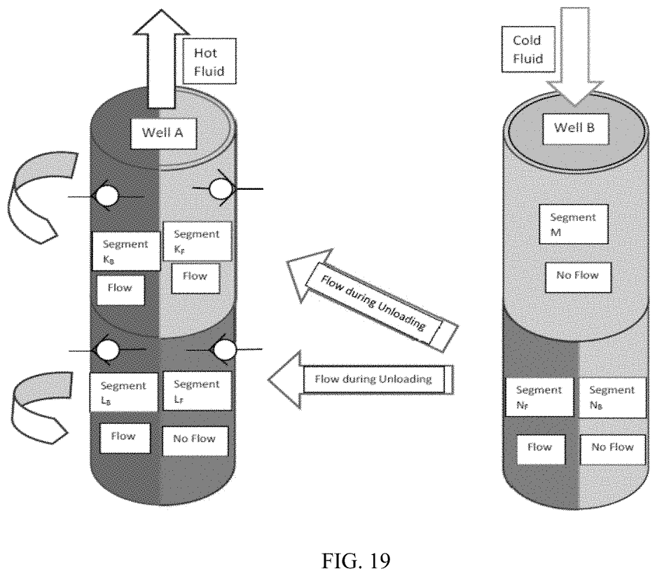

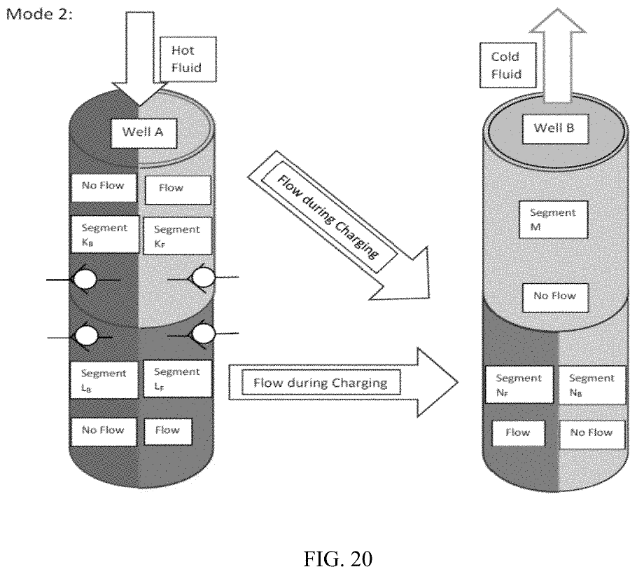

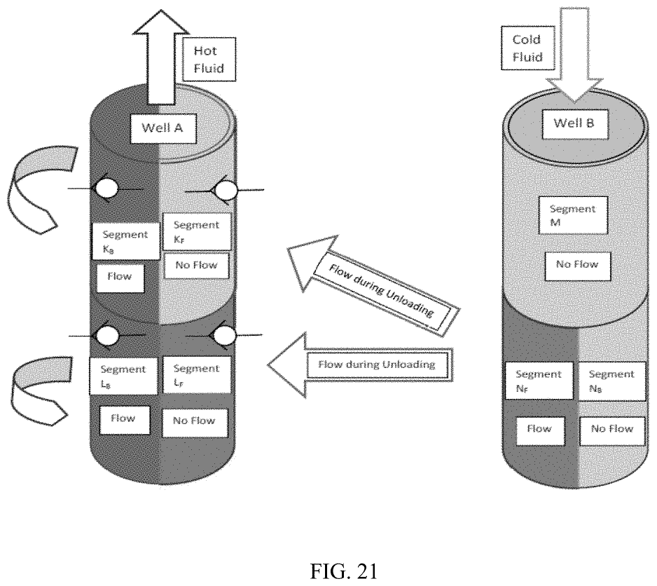

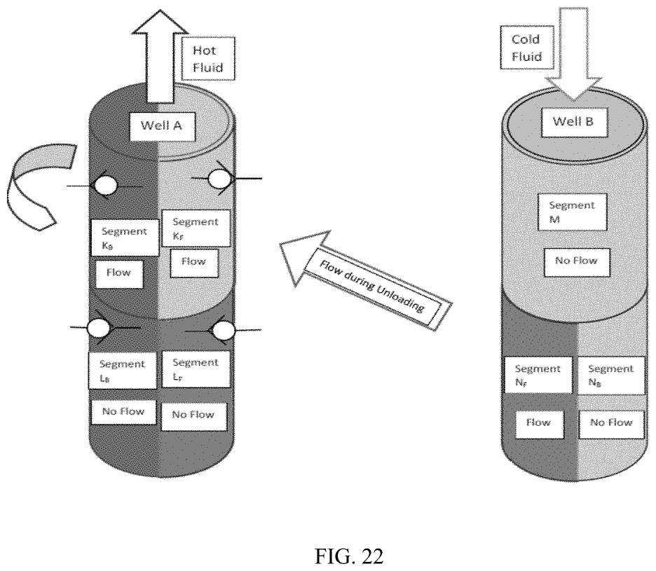

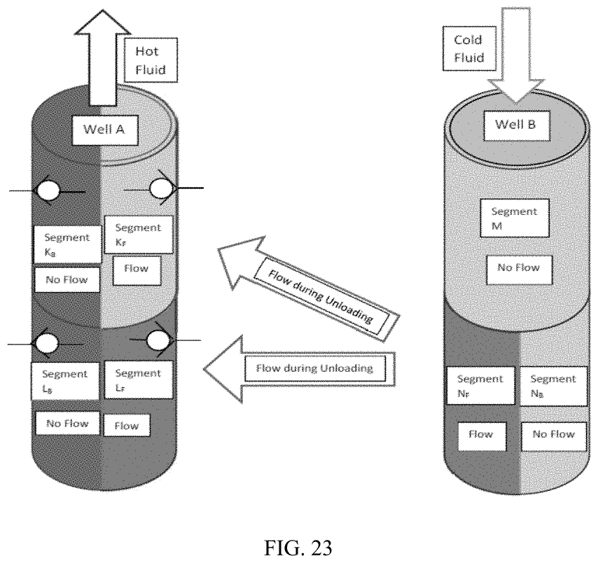

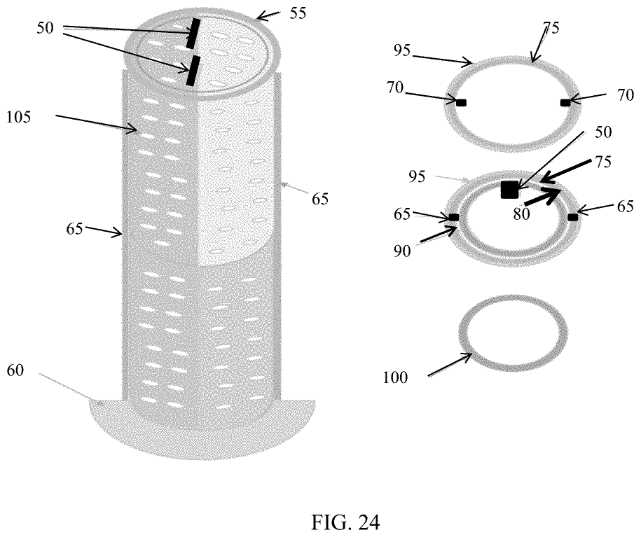

Referring to FIG. 18—FIG. 24, SS-ThEnStoR provides for a break valve operation mode, flow-controlled bi-cylindrical valve operation mode, mechanical lift operation mode, and electrical lift operation mode. While only a single break valve in shown per segment of the wells, there is actually a break valve for each perforation and each segment has multiple perforations.

Referring to FIG. 18, heat is stored in the subsurface fractured rock (i.e., loading or charging phase). During this operation, thermal fluid in a hot state is pushed from the lower half of well A through the perforations on L_{B}, facing the lower half of well B, N_{F}. L_{F} and N_{F} are not necessarily aligned horizontally. The alignments are also shown in FIG. 14. Thermal fluid in a cold state is received by well B through the perforations on N_{F}. The thermal fluid deposits heat to the fractured rock in between wells A and B. For this operation to be possible, break valves are placed in each perforation of each segment of the wells as shown in FIG. 18.

Referring to FIG. 19, the heat is removed where thermal fluid in a hot state flows out of well A (i.e., unloading phase). The reverse flow as depicted in FIG. 19 enters well A from segments K_{B}, K_{F}, and L_{B} from N_{F} of well B.

Referring to FIG. 20, heat is stored in the subsurface fractured rock (i.e., loading or charging phase). During this operation, thermal fluid in a hot state is pushed from the lower half of well A through the perforations on L_{F}, facing the lower half of well B, N_{F}. L_{F} and N_{F} are not necessarily aligned horizontally. The alignments are also shown in FIG. 14. Thermal fluid in a cold state is received by well B through the perforations on N_{F}. The fluid deposits heat to the fractured rock in between wells A and B. For this operation to be possible, break valves are placed in each perforation of each segment of the wells as shown in FIG. 20.

Referring to FIG. 21, the depicted mode of operation incorporates the charging phase of FIG. 18 or FIG. 20 and the discharging phase where the reverse flow, as depicted in FIG. 21, enters well A from segments K_{B} and L_{B} from N_{F} of well B.

Referring to FIG. 22, the depicted mode of operation incorporates the charging phase of FIG. 18 or FIG. 20 and discharging phase where the reverse flow, as depicted in FIG. 22, enters well A from segments K_{B} and K_{F} from segment N_{F} of well B.

Referring to FIG. 23, the depicted mode of operation incorporates the charging phase of FIG. 18 or FIG. 20 and discharging phase where the reverse flow, as depicted in FIG. 23, enters well A from segments K_{F} and L_{F} from segment N_{F} of well B.

Other modes of operation involve: (i) the charging phase of FIG. 20 and the discharging phase of FIG. 23; (ii) unloading phases in each mode of operation above combined with in-flow to well A through the bottom of well A; and (iii) well A divided into more segments than depicted and the reverse flow (i.e., unloading) into well A can be any combination of these segments.

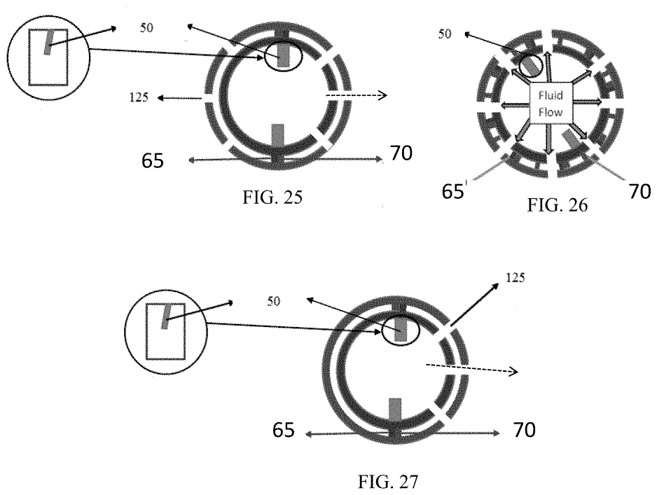

Referring to FIG. 25, a flow-controlled bi-cylindrical (FCB) valve is depicted. The FCB valve is made up of two concentric cylinders that are separated by thin bearing 55 at the top and bottom positions, and any other place along the length of cylinders that may be necessary for stability.

Inner cylinder 80 has angled rectangular fin 50 on its inside that are so angled as to cause this cylinder to rotate when a flow goes through inner cylinder 80. Flow through the cylinder in the opposite direction causes inner cylinder 80 to rotate in the opposite direction. Inner cylinder 80 also has flanges 65 on the outside. There may be as many flanges 65 as is necessary. Outer cylinder 75 has corresponding flanges 70 on its inside. Flanges 70 may be rectangular in cross-section or any other shape that achieve a seal. The seal should be formed when the flanges of inner cylinder 80 and outer cylinder 75 come in contact due to the rotation of inner cylinder 80, as depicted in the middle right diagram of FIG. 25. If a seal is not critical, then the flanges can be more “loosely” designed without expending effort to achieve a tight seal. The left diagram of FIG. 25 shows inner cylinder 80 only, which is perforated with holes (perforations 105). Each segment may be perforated differently to suit the purpose. Depending on the intended operation, the entire outer and inner cylinders may be fully perforated or each may be perforated differently. Outer cylinder 75 may be perforated to match the inner cylinder 80 depending on the dynamics required. In one instance, a rotation of inner cylinder 80 line-up the holes of the inner and outer cylinder. The opposite rotation misaligns these holes. When the holes are aligned, the flow takes places. The cylinders may be perforated to cause flow to the left, to the right, or straight through, depending on the alignment of the holes.

Referring to FIG. 25, the activation of FCB value valve causes flow to change direction by 90° to the left or to the right. Fin 50, as depicted in FIG. 25, causes the thermal fluid that comes up the inner cylinder rotate the said cylinder counter-clockwise until the flanges 65 and 70 jam. The flow of fluid is actuated where a unit of orifice 125 of the outer cylinder aligns with a unit of orifice 125 of the inner cylinder, as depicted by the dotted line. At this point the rotation stops. Since the flanges 65 and 70 go all the way to the bottom of the cylinders, the flow does not enter the gap between the two cylinders on the left side. Additionally, the flow is blocked from flowing through the orifices on the left side. The right side is now in play and hence the flow goes to the right. When flow goes down the inner cylinder all the actions are reversed. While FIG. 25 shows only one pair of flanges on each cylinder, there may be multiple pairs which facilitate less rotational movement of the inner cylinder. As per FIG. 25, there is 180° rotation of the inner cylinder.

Referring to FIG. 26, the flow activates the FCB valve to either cause the flow to continue straight through or to cause flow to go through all sections of the side walls of the cylinder. In FIG. 26, the flow is up. The orientation of the rectangular fin 50 causes the inner cylinder to rotate counter-clockwise. Flanges 65 (attached to the outside of the inner cylinder) jam flanges 70 (attached to the inner wall of the outer cylinder) to stop the rotation. The flow then goes out through the perforations as shown. When the flow goes down the inner cylinder, the inner cylinder rotates in the opposite direction. This action closes off the flow through the perforations. Thereby, the fluid is transported straight through the cylinder.

Referring to FIG. 27, the flow activates the FCB valve to either cause the flow to continue straight through or to cause flow to go through some sections of the side walls of the cylinder. In FIG. 27, the flow is up. The orientation of the rectangular fin 50 causes the inner cylinder to rotate counter-clockwise. Flanges 65 (attached to the outside of the inner cylinder) jam flanges 70 (attached to the inner wall of the outer cylinder) to stop the rotation. The flow then goes out through the perforations as shown. When the flow goes down the inner cylinder, the inner cylinder rotates in the opposite direction. This action closes off the flow through the perforations. Thereby, the fluid is transported straight through the cylinder.

In a mechanical lift may be used such that the inner cylinder is lifted by rods or wires by a few inches or far enough to: (i) misalign the holes through which flow is not needed and (ii) align the ones for which flow is needed. Releasing the inner cylinder reverse the effect. These rods or wires are connected to the lift mechanism on the surface of the earth.

An electrical motor is attached to the base of the inner cylinder. The motor is secured to the ground and the inner cylinder is attached to the disc bearing upon which it rests. Power leads to the motor are in the cement between the outer cylinder and the rock or inside the inner cylinder. Alternatively, the motor can be remote controlled. This motor can produce the same rotations as the fins in the FCB valve. For the various operations of the wells, different combinations of valves maybe needed. For all operations, the Electronic Lift Model and the Mechanical Lift Model can be used as long as the relevant perforations are made in the relevant locations. Otherwise, the models of the FCB valve in FIG. 25—FIG. 27 can be combined in different ways to accommodate the modes of operation of wells A and B (FIG. 18—FIG. 23). For instance, where the mode of operation in FIG. 18, the upper segment of well A can use model of the FCB valve depicted in FIG. 27. In contrast, the lower half can use the mode of operation in FIG. 18. Other combinations are possible for different flow patterns. Note that these two models of the valve can be used as separate entities or combined as a single entity (meaning a single inner cylinder for both and a single outer cylinder for both). Based on the operation of the wells, any two models can be combined as a single entity. Further, for multiple segments, these valves can be combined as described above, separately or as single entities.

### OTHER EMBODIMENTS

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which does not depart from the spirit or scope of the present inventive discovery. Such modifications are also intended to fall within the scope of the appended claims.

### REFERENCES CITED

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

What is claimed is:

1. A system for storing and retrieving energy from or to the subsurface region, comprising:
a heat source or an energy consumer thermally connected to a first fluid, wherein the first fluid is transported through a first well fluidically connected to a second well;
a slot sawed into a rock, wherein the slot is below an earth surface;
a cable and tubing operatively connected the first well to the second well, wherein the cable and the tubing are partially encapsulated by casing, wherein the cable stores heat;
a plurality of materials filled into the slot, wherein the plurality of materials is in a liquid state or gas state;
a first hole disposed beneath a first rig, wherein the first hole is surrounded by the first well;
a second hole disposed beneath a second rig, wherein the second hole is surrounded by the second well; and
wherein the first hole and the second hole are configured to be vertical or slanted.

2. The system of claim 1, wherein the tubing is operatively connected to the cable such that a first end of the tubing is clamped to a first end of the cable within the first rig and the second end of the tubing is clamped to a second end of the cable within the second rig.

3. The system of claim 1, wherein the plurality of materials is selected from the group consisting of steel balls, scrap steel, gravel, alumina, bauxite, water, air, and ropes for heat storage.

4. The system of claim 1, wherein the slot is disposed in a vertical direction, a horizontal direction, or an inclined direction.

5. The system of claim 1, wherein the first well and the second well are of a circular shape, a rectangular shape, an ellipsoidal shape, or a square shape.

6. The system of claim 1, wherein the heat source comprises solar energy, nuclear energy, geothermal energy, electrical, organic wastes, and converted wind turbine energy.

7. The system of claim 1, wherein the fluid is in a gas phase, liquid phase, supercritical phase, or dual phase.

8. The system of claim 1, wherein the first fluid is transported through the slot, the heat source, and the energy consumer in a single closed-loop system, a binary closed-loop system, or an open loop system.

9. The system of claim 8, wherein the binary closed-loop system further comprises a second fluid and a heat exchanger, wherein the heat exchanger is fluidically connected to the first fluid, the second fluid, and the slot.

10. The system of claim 8, wherein the single-loop system comprises the first fluid transported from the heat source to the slot in a heated state and subsequently transported from the slot to the heat source in a cooled state.

11. The system of claim 8, wherein the single-loop system comprises the first fluid transported from the energy consumer to the slot in a cooled state and subsequently transported from the slot to the energy consumer in a heated state.

12. A system for storing and retrieving sub-surface energy, comprising:
a fractured body of rock, wherein the fractured body or rock resides below an earth surface;
a thermal fluid circulated through the fractured body of rock via tubing;
a rock mass below the earth surface, wherein the rock mass is a continuation of the fractured body of rock;
a first well disposed within a first hole, wherein the first hole is operatively connected to the fractured body of rock;
a second well disposed within a second hole, wherein the second hole is operatively connected to the fractured body of rock;
wherein the first well contains at least a first segment, a second segment, and a third segment, the second well contains at least a fourth segment and a fifth segment;
wherein the first segment, the second segment, the third segment, the fourth segment, and the fifth segment comprise perforations fitted with valves; and
wherein the first hole and the second hole are configured to be vertical or slanted.

13. The system of claim 12, wherein the first well and the second well comprise the valves and a cement layer connected to a first tubing layer, wherein the first tubing layer is connected to a first hollow layer, wherein the first hollow layer is connected to a second tubing layer, wherein the second tubing layer is connected to the second hollow layer, wherein the valves span from the cement layer, the first tubing layer, the first hollow layer, and the second tubing layer.

14. The system of claim 12, wherein the second segment and the third segment comprise at least one angled fin, at least one outer flange, a thin bearing, and a disc bearing.

15. The system of claim 12, wherein the first segment and the fourth segment comprise at least one flange and a cement layer.

16. The system of claim 12, wherein the tubing is connected to (i) electrical motors for causing rotation, (ii) a thin bearing, and (iii) a disc bearing.

17. The system of claim 12, wherein the perforations on the outer tubing are covered with sieves to prevent sand from entering between the cylinders, wherein the sieves are disposed on inner or outer faces or both the inner and outer faces of an outer cylinder.

18. The system of claim 12, wherein the thermal fluid flows from any combination of the first, second, third, fourth, and fifth segments such that the thermal fluid is hot when released by the first well and the thermal fluid is cold when received by any combination of segments in the second well.

19. The system of claim 12, wherein the thermal fluid flows from the second segment to the third segment such that the thermal fluid is hot when received by the first well and the thermal fluid is cold when released by the second well, wherein the second well has a bottom level higher than a bottom level of the first well or the second well has the bottom at an identical level to the bottom level of the first well.

20. The system of claim 12, wherein the thermal fluid flows from the second segment to the third segment such that the thermal fluid is hot when released by the first well and the thermal fluid is cold when received by the second well, wherein the second well has a bottom level higher than a bottom level of the first well or the second well has the bottom at an identical level to the bottom level of the first well.
